(19) United States
(12) Patent Application Publication
(10) Pub. No.: US 2008/0299840 A1
(43) Pub. Date: Dec. 4, 2008

(54) CONTACT AND CONNECTOR USING THE CONTACT

(75) Inventors: Ryoji KITAMUKI, Tokyo (JP); Yoshinori YABE, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DDK LTD., Tokyo (JP)

(21) Appl. No.: 12/126,833

(22) Filed: May 23, 2008

(30) Foreign Application Priority Data
May 28, 2007 (JP) 2007-140,416

(51) Int. Cl. H01R 9/24

(52) U.S. Cl. 439/884

(57) ABSTRACT

An L-shaped contact includes a contact portion adapted to contact a mating object, a fixed portion to be fixed to a housing, and a connection portion to be connected to a connecting object, and a hole formed in a bent portion between the fixed portion and the connection portion. When the contact is fixed to the housing, the contact is inserted into the housing by pushing an end face of the hole. The L-shaped contact ensures a stable contacting surface area for being pushed by a jig and enables to bear a heavy-electric current to pass therethrough without adversely affecting miniaturization of a connector and extremely narrow pitches of the conductors.

### BACKGROUND OF THE INVENTION

This invention relates to a contact for use in electric and electronic appliances such as digital cameras, video cameras, mobile phone terminals, and the like, and more particularly to a contact having a specific fixing structure for it.

A contact 50 hitherto used is substantially L-shaped as shown in FIG. 5, and comprises at least a contact portion 52 adapted to contact a mating object, a fixed portion 54 to be fixed to a housing 82, and a connection portion 56 to be connected to a connecting object. The contact 50 is fixed in one of inserting holes 84 formed in the housing 82 by press-fitting, hooking or the like. When the contacts 50 are inserted into the inserting holes 84 of the housing 82, two shoulders 58 of the contacts provided between said fixed portion 54 and said connection portion 56 are pushed by means of a given jig to achieve the insertion of the contacts into the housing as shown in FIG. 6.

Patent documents proposed by the applicant of the present application, incorporated herein are Patent Document 1 (Japanese Patent Application Opened No. H11-312,560/1999) and Patent Document 2 (Japanese Patent Application Opened No. 2004-206,908) both disclosing contacts having a hole at a predetermined position, and Patent Document 3 (Japanese Patent Application Opened No. H09-050,842) disclosing contacts having a portion to be pushed by a jig.

### Patent Literature 1

According to the abstract of the Japanese Patent Application Opened No. H11,-312,560/1999, this invention has an object to provide an electrical connector 10 enabling high speed transmission without causing any cross talk, although socket contacts 14 or 141 of a tuning fork type are arranged with a narrow pitch. Disclosed is an electrical connector 10 including an insulator 12 and socket contacts 14 held and fixed by the insulator 12 and each consisting of two contact pieces 18 arranged in parallel with each other, the two contact pieces each having at one end a connection portion 26 to be connected to a substrate, substantially at its center a fixed portion 24 to be fixed to said insulator, and at the other end a contact portion 22 to contact a mating contact, wherein said socket contacts 14 are each formed with a hole 20 in the proximity of the middle of the fixed portion 24 of the socket contact 14.

Incidentally, claim 1 of the Japanese Patent Application Opened No. H11-312,560/1999 recites an electrical connector including an insulator and socket contacts held and fixed by the insulator and each consisting of two contact pieces arranged in parallel with each other, the two contact pieces each having at one end a connection portion to be connected to a substrate, substantially at its center a fixed portion to be fixed to said insulator, and at the other end a contact portion to contact a mating contact, wherein said socket contacts are each formed with a hole in the proximity of the middle of the fixed portion of the socket contact.

### Patent Literature 2

According to the abstract of the Japanese Patent Application Opened No. 2004-206,908, this invention has an object to provide an electrical connector 10 enabling characteristic impedance to be matched while ensuring elasticity of contact portions 16 of contacts 14. Disclosed is an electrical connector 10 including a required number of contacts 14 each having a contact portion 16 adapted to contact a mating connector or a substrate, a fixed portion 18 to be fixed to a housing 12, and a connection portion 22 to be connected to a substrate, and the housing 12 for fixing the contacts 14 and having a fitting opening 28 into which a mating connector or the like is inserted, wherein the contacts 14 are arranged at the same interval in the longitudinal direction, and the contacts 14 are each provided with a hole 20 between the contact portion 16 and the fixed portion 18. The hole 20 is the widest at the side nearest to the contact portion 16 and becomes progressively narrower toward the fixed portion 18.

Incidentally, claim 1 of the Japanese Patent Application Opened No. 2004-206,908, recites an electrical connector including a required number of contacts each having a contact portion adapted to contact a mating connector or a substrate, a fixed portion to be fixed to a housing, and a connection portion to be connected to a substrate, and the housing for fixing the contacts and having a fitting opening into which a mating connector or a substrate is inserted, wherein said contacts are arranged at the same interval in the longitudinal direction, and said contacts are each provided with a hole between the contact portion and the fixed portion. Claim 2 recites that in the electrical connector as claimed in claim 1, said contacts adjacent to each other in the longitudinal direction are arranged at the same interval so as to cause characteristic impedance to be matched. Claim 3 recites that in the electrical connector as claimed in claim 2, said hole is so formed in each of the contacts that the hole is the widest at the side nearest to said contact portion and becomes progressively narrower toward said fixed portion for the purpose of increasing the elasticity of the contact portion. Claim 4 recites that in the electrical connector as claimed in claim 2 or 3, said hole is triangular.

### Patent Literature 3

According to the abstract of the Japanese Patent Application Opened No. H09-050,842, this invention has an object to provide a press-in contact 10 which can be easily press-fitted in a circuit board by means of a simple jig. Disclosed is a press-in contact 10 comprising two plate-shaped pieces 13 whose positioning parts 12 have a pushing face A 14 adapted to be pushed by a jig, and a jointing portion 15 for jointing the plate-shaped pieces 13 and a connection portion 18, wherein the connection portion 18 is bent into a substantially J-shape so that center axes of the positioning parts 12 and connection portion 18 are staggered, and said plate-shaped pieces 13 are bent into a C-shape so that center axes of the plate-shaped pieces 13 of the positioning parts 12 and the connection portion 18 are staggered.

Incidentally, claim 1 of the Japanese Patent Application Opened No. H09-050,842 recites a press-in contact including a connection portion to be connected to a mating connector, a press-fitting portion to be press-fitted and fixed in a cylindrical through-hole of a printed circuit board, and a contact portion to be conducted to a substrate, wherein said press-in contact comprises two plate-shaped pieces whose positioning parts have a pushing face A adapted to be pushed by a jig, and a jointing portion for jointing the plate-shaped pieces and the connection portion shaped substantially in the form of a J-shape, and center axes of the positioning parts and the connection portion are staggered. Claim 2 recites a method for producing a press-in contact comprising sequentially performed steps of initially punching a metal plate to form a press-in contact material in the form of a plate, drawing the punched press-in contact material to form its press-fitting portion to have a substantially V-shaped cross-section, deforming the press-fitting portion having the substantially V-shaped cross-section worked in said drawing step so as to form the inside of the press-fitting portion into a U-shape, drawing the outside of the press-fitting portion to have a plurality of arc portions and straight portions, further forming plate-shaped pieces 13 and a connection portion 18 by cutting, thereafter bending the connection portion 18 into substantially a J-shape, and finally cut-out the formed press-in contact away from the metal plate. Claim 3 recites a press-in contact including a connection portion to be connected to a mating connector, a press-fitting portion to be press-fitted and fixed in a cylindrical through-hole of a printed circuit board, and a contact portion to be conducted to a substrate, wherein said press-in contact comprises two plate-shaped pieces whose positioning parts have a pushing face A adapted to be pushed by a jig, and a jointing portion for jointing the plate-shaped pieces and the connection portion, and said plate-shaped pieces are bent into a C-shape so that center axes of the plate-shaped pieces of the positioning parts and the connection portion are staggered.

In recent years, with the miniaturization of electric and electronic appliances, connectors have also been miniaturized and connectors having conductors arranged with extremely narrow pitches have been promoted as well. In the case that a connector is used for electric power purpose, a heavy-current might pass through the contacts of the connector, and therefore it is preferable for the contacts to have wide areas as much as possible in order to pass the heavy-current in consideration of electric resistance. When contacts are inserted into an insulator such as a housing, press-fitting of the contacts are generally performed by the use of a jig or the like. When using a jig, the contacts must necessarily be provided with portions which are to be pushed by the jig. As the portions to be pushed by the jig, two shoulders are often provided between the fixed portion and the connection portion of a contact (as shown in FIG. 5) and the shoulders are pushed by a jig (as shown in FIG. 6) as described in the paragraph explaining the prior art. With such shoulders, passing electric current would be constrained and, moreover, flat faces to be pushed would become narrower due to rounded corners and shear drop caused when forming the contacts.

In the Patent Literatures 1 and 2, although the contacts are each provided with a hole, such hole is intended to serve to match the characteristic impedance, thus cannot be pushed by a jig.

Patent Literature 3 relates to the press-in contact which is directly press-fitted into a substrate or circuit board, but not into an insulator such as a housing. Therefore, the contact is press-fitted from the side connecting to a mating object without any limitation of the thickness of a housing.

### SUMMARY OF THE INVENTION

In view of the problems of the prior art described above, the present invention has been accomplished and has an object to provide a contact ensuring its stable contacting surface area for being pushed by a jig and enabling to bear a heavy-electric current to pass therethrough without adversely affecting miniaturization of a connector and extremely narrow pitches of the conductors.

The object as described above can be accomplished by the contact 10 as claimed in claim 1 including a contact portion 12 adapted to contact a mating object, a fixed portion 14 to be fixed to a housing 82, and a connection portion 16 to be connected to a connecting object, in which said fixed portion 14 of said contact is bent substantially vertically to form bent pieces 18 whose end faces 20 are pushed to insert the contact 10 into said housing 82 when the contact 10 is fixed to said housing 82.

Moreover, the object as described above can also be achieved by the L-shaped contact 30 as claimed in claim 2 including a contact portion 32 adapted to contact a mating object, a fixed portion 34 to be fixed to a housing 82, and a connection portion 36 to be connected to a connecting object, in which said L-shaped contact is formed between said fixed portion 34 and said connection portion 36 with a bent portion which is formed with a hole 38 whose end face 40 is pushed to insert the contact 30 into said housing 82 when the contact 30 is fixed to said housing 82.

The connector 80 as claimed in claim 3 is characterized in that when the contact 10 or 30 as claimed in claim 1 or 2 is fixed to said housing 82, said contact 10 or 30 is inserted into said housing 82 by pushing said end faces 20 of said bent pieces 18 or said end face 40 of said hole 38.

As can be seen from the above descriptions, the contact according to the invention can bring about the following significant effects.

(1) In the contact 10 including a contact portion 12 adapted to contact a mating object, a fixed portion 14 to be fixed to a housing 82, and a connection portion 16 to be connected to a connecting object, according to the invention of claim 1 said fixed portion 14 of said contact is bent substantially vertically to form bent pieces 18 whose end faces 20 are pushed to insert the contact 10 into said housing 82 when the contact 10 is fixed to said housing 82. Therefore, the contact according to the invention can ensure stable contact areas to contact a jig 90 and hence achieve stable press-fitting of the contact, and enables to bear a heavy-current to pass therethrough without adversely affecting miniaturization of a connector 80 and extremely narrow pitches of the conductors.
(2) In the L-shaped contact 30 including a contact portion 32 adapted to contact a mating object, a fixed portion 34 to be fixed to a housing 82, and a connection portion 36 to be connected to a connecting object, according to the invention of claim 2 said L-shaped contact is formed between said fixed portion 34 and said connection portion 36 with a bent portion which is formed with a hole 38 whose end face 40 is pushed to insert the contact 30 into said housing 82 when the contact 30 is fixed to said housing 82. Consequently, the contact according to the invention can ensure stable contact areas to contact a jig 90 and hence achieve stable press-fitting of the contact, and enables to bear a heavy-current to pass therethrough without adversely affecting miniaturization of a connector 80 and extremely narrow pitches of the conductors.
(3) The connector 80 as claimed in claim 3 is characterized in that when the contact 10 or 30 as claimed in claim 1 or 2 is fixed to said housing 82, said contact 10 or 30 is inserted into said housing 82 by pushing said end faces 20 of said bent pieces 18 or said end face 40 of said hole 38. Therefore, the connector 80 according to the invention can ensure stable contact areas of contacts to contact a jig 90 and hence achieve stable press-fitting of the contacts, and enables heavy-current to pass therethrough without adversely affecting miniaturization of the connector 80 and extremely narrow pitches of the conductors.

The invention will be more fully understood by referring to the following detailed specification and claims taken in connection with the appended drawings.

### BRIEF DESCRIPTION OF THE DRAWINGS

FIG. 1 (A) is a perspective view of a contact according to the invention;

FIG. 1 (B) is a perspective view of another contact according to the invention;

FIG. 1 (C) is a perspective view of a further contact according to the invention;

FIG. 2 (A) is a view for explaining press-fitting of the contact shown in FIG. 1 (B);

FIG. 2 (B) is a view for explaining press-fitting of the contact shown in FIG. 1 (C);

FIG. 3 (A) is a perspective view of a connector using the contacts shown in FIG. 1 (A);

FIG. 3 (B) is a perspective view of a connector using the contacts shown in FIG. 1 (B);

FIG. 3 (C) is a perspective view of a connector using the contacts shown in FIG. 1 (C);

FIG. 4 is a perspective view of a housing used in the connector according to the invention;

FIG. 5 is a perspective view of a contact of the prior art; and

FIG. 6 is a view for explaining press-fitting of the contact of the prior art.

### DESCRIPTION OF THE PREFERRED EMBODIMENTS

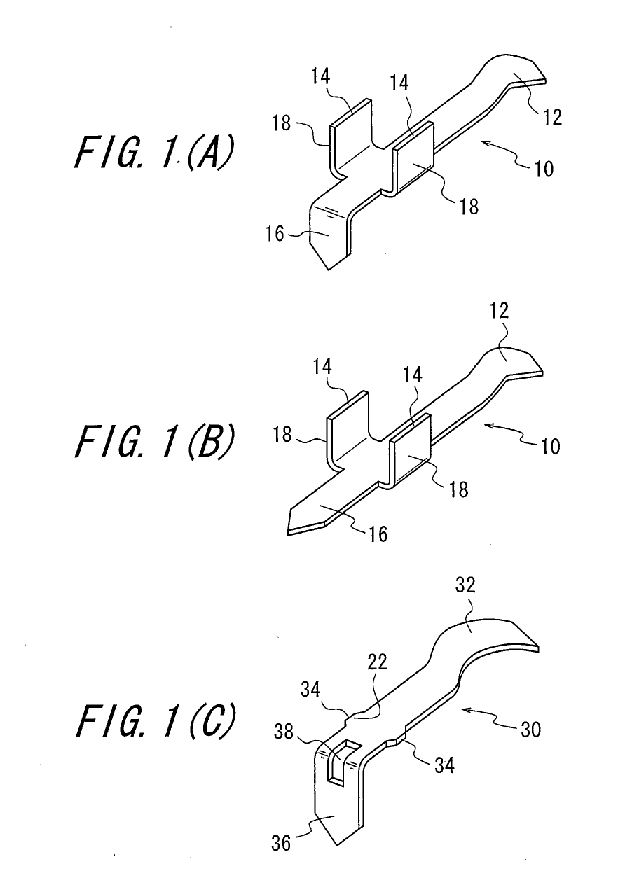

One embodiment of the connector according to the invention will be explained with reference to FIGS. 1 (A) to 4.

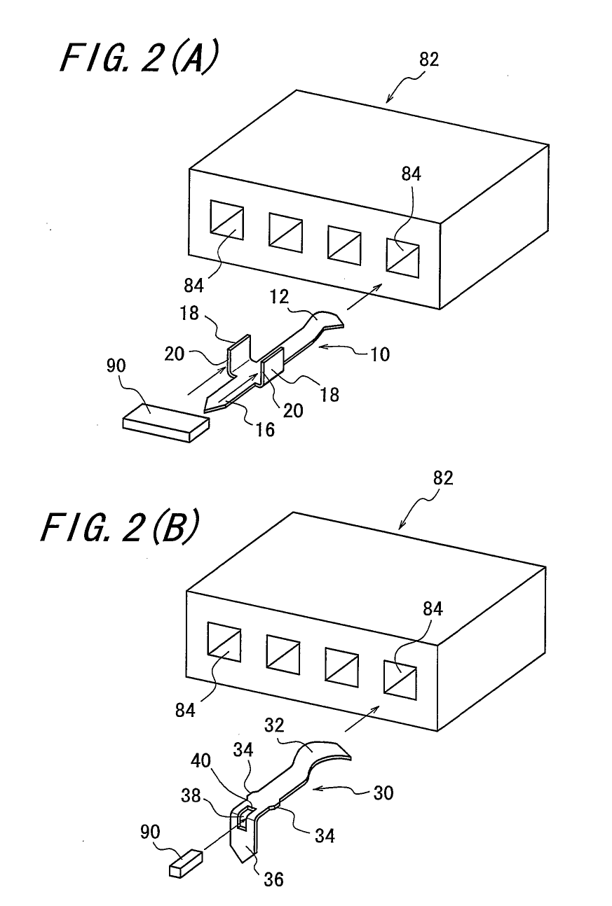

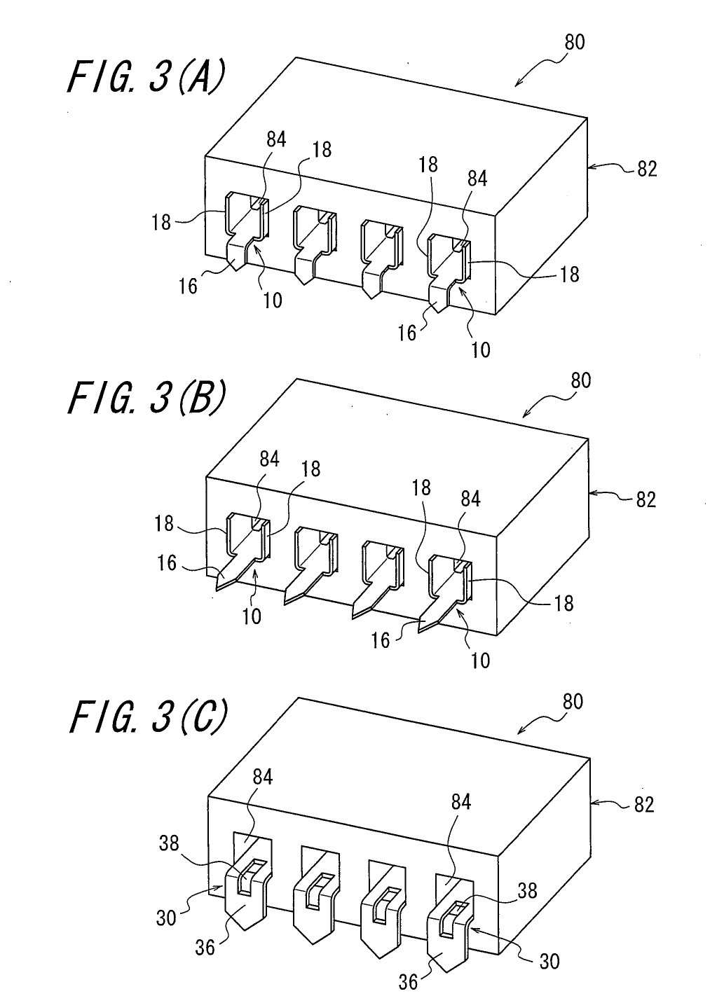

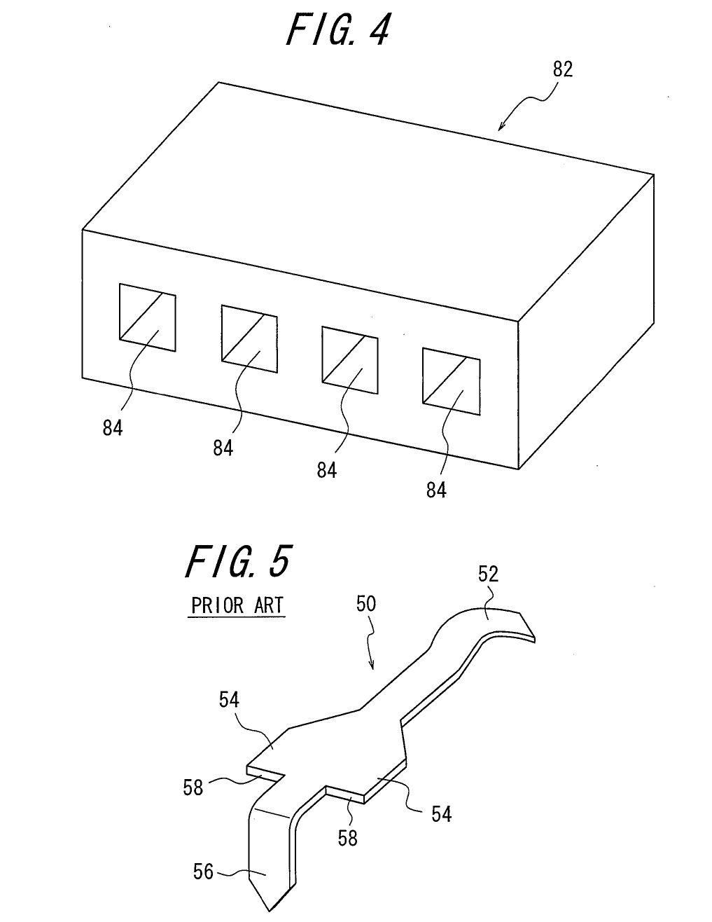

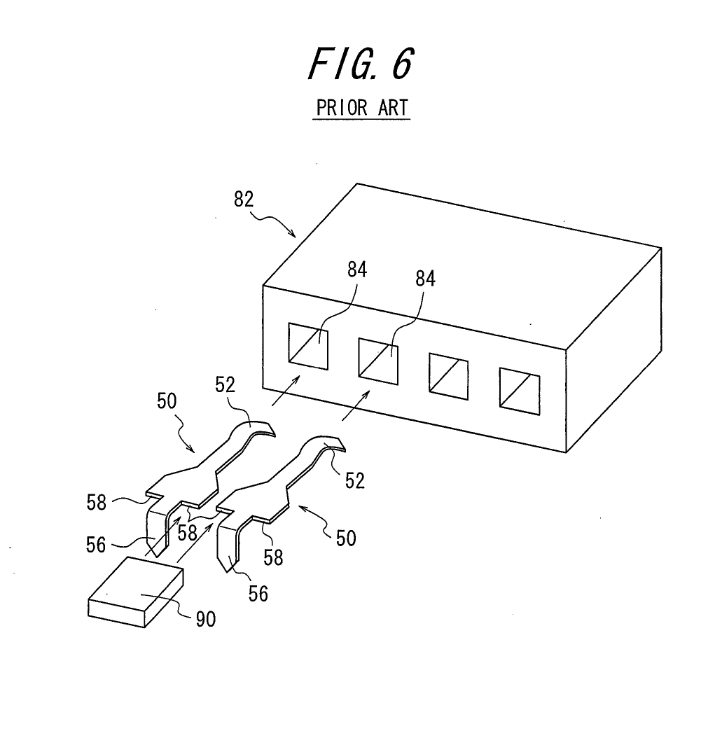

FIG. 1 (A) is a perspective view of the contact according to the invention, while FIG. 1 (B) is a perspective view of another contact according to the invention, and FIG. 1 (C) is a perspective view of a further contact according to the invention. FIG. 2 (A) is a view for explaining press-fitting of the contact shown in FIG. 1 (B), and FIG. 2 (B) is a view for explaining press-fitting of the contact shown in FIG. 1 (C). FIG. 3 (A) is a perspective view of a connector using the contacts shown in FIG. 1 (A), while FIG. 3 (B) is a perspective view of a connector using the contacts shown in FIG. 1 (B), and FIG. 3 (C) is a perspective view of a connector using the contacts shown in FIG. 1 (C). FIG. 4 is a perspective view of a housing used in the connector according to the invention.

The contacts 10 and 30 are made of a metal and formed by means of the press-working of the known technique. Preferred metals from which to form said contacts include brass, beryllium copper, phosphor bronze and the like which comply with the requirements as to springiness, electric conductivity, and the like.

The contact shown in FIG. 1 (A) will be explained with reference to the drawing. The contact 10 comprises at least a contact portion 12 adapted to contact a mating object, a fixed portion 14 to be fixed to the housing 82, and a connection portion 16 to be connected to a connecting object.

Said contact portion 12 is the portion adapted to contact a connecting object such as a contact of a mating connector, substrate, flexible printed circuit board, and flexible flat cable. The contact portion 12 may be suitably designed to be a shape and a size so as to permit the contact portion 12 to easily contact the connecting object. In the shown embodiment, the contact portion 12 is substantially L-shaped.

The connection portion 16 is the portion to be connected to a substrate, flexible printed circuit board or cable. The shape and size of the connection portion may be suitably designed in consideration of its connectivity, strength and the like. In the shown embodiment, the connection portion 16 is of a surface mounting type (SMT), but it may be of an L-shaped dip type or straight dip type. FIG. 1 (B) shows the straight dip type of the contact 10 which is different from the contact 10 shown in FIG. 1 (A) only in the shape of connection portion. If the connection portion 16 of the contact 10 shown in FIG. 1 (A) is extended further in the extending direction of the connection portion 16, the contact 10 may be varied to a contact of the L-shaped dip type (not shown).

The fixed portion 14 is the portion to be fixed to the housing 82 as an insulator. In the shown embodiment, the fixed portion 14 is formed by two bent pieces 18 obtained by bending two parts of the contact substantially vertically. The fixed portion 14 is formed by said bent pieces 18 to ensure contacting portions which a jig 90 contacts. The shape and size of said bent pieces 18 may be suitably designed taking into account the miniaturization of the connector 80, the strength of the housing 82, the holding force for the contact, easiness of press-fitting and the like. In the illustrated embodiment, the fixed portion 14 is substantially U-shaped.

The contact shown in FIG. 1 (C) will be explained with reference to the drawing. Said contact 30 is substantially L-shaped and comprises at least a contact portion 32 adapted to contact a mating object, a fixed portion 34 to be fixed to the housing 82, a connection portion 36 to be connected to a connecting object, and a hole 38 formed in a bent portion between said fixed portion 34 and said connection portion 36.

Said contact portion 32 is adapted to contact a connecting object such as a contact of a mating connector, substrate, flexible printed circuit board, and flexible flat cable. The contact portion 32 may be suitably designed to be a shape and a size so as to permit the contact portion 32 to easily contact the connecting object. In the shown embodiment, the contact portion 12 is substantially L-shaped.

Said connection portion 36 is the portion to be connected to a substrate, flexible printed circuit board or cable. The shape and size of the connection portion may be suitably designed in consideration of its connectivity, strength and the like. In the shown embodiment, the connection portion 36 is of a surface mounting type (SMT), but it may be of an L-shaped dip type. If the connection portion 36 of the contact 30 shown in FIG. 1 (C) is extended further in the extending direction of the connection portion 36, the contact 30 may be varied to a contact of the L-shaped dip type (not shown).

The fixed portion 34 is the portion to be fixed to the housing as the insulator and is formed with bosses as press-fitting portion 22 for press-fitting the contact in the housing. The shape and the size of said fixed portion 34 may be suitably designed in consideration of the holding force for the contact, the strength of the housing 82 and the like.

There is provided the hole 38 in the bent portion between said fixed portion 34 and said connection portion 36. Said hole 38 serves to provide a portion which is pushed by a jig 90 for press-fitting the contact 30 into the housing. The shape and size of said hole 38 may be suitably designed taking into account the easiness of pushing by the jig 90, holding force and strength of the contact, electric current passing through the contact and the like. In the illustrated embodiment, the hole 38 is substantially rectangular and has 1.0 mm in width and 2.0 mm in length.

Connectors 80 using the contacts shown in FIGS. 1 (A), 1 (B) and 1 (C), respectively will be explained hereinafter. When the contacts 10 and 30 are used in the connectors 80, respectively, the contacts are press-fitted into the housings 82 as insulators. The housing 82 will be explained hereinafter.

The housing 82 will be explained. The housing is formed from an electrically insulating plastic material by means of the injection molding of the known technique. The materials for the housing may be suitably selected in consideration of dimensional stability, workability, manufacturing cost, and the like, and generally include polybutylene terephthalate (PBT), polyamide (66PA or 46PA), liquid crystal polymer (LCP), polycarbonate (PC) and the like and combination thereof.

Said housing 82 is formed with inserting holes 84 into which a required number of contacts 10 or 30, respectively. The inserting holes 84 are somewhat larger than said contacts 10 or 30 so that the contacts 10 or 30 are fixed in the inserting holes 84 by press-fitting the bent pieces 18 or press-fitting portion 22 of the contacts in the inserting holes 84. The inserting holes 84 may be suitably designed in consideration of the shapes and sizes of said contacts 10 and 30, the miniaturization of the connector 80, the strength of the housing 84, and the like.

Finally, the method of press-fitting will be explained.

First, in the case of the contact 10 shown in FIG. 1 (B), as shown in FIG. 2 (A) the contact 10 is inserted (press-fitted) with its contact portion 12 into the inserting hole 84 of the housing 82 from its connection side (that is, the left side in the drawing) by pushing the end faces 20 of said bent pieces 18 of said fixed portion 14 by means of a jig 90.

In the case of the contact 30 shown in FIG. 1 (C), as shown in FIG. 2 (B) the contact 30 is inserted (press-fitted) with its contact portion 32 into the inserting hole 84 of the housing 82 from its connection side (that is, the left side in the drawing) by pushing the end face 40 of said hole 38 formed in the bent portion between said fixed portion 34 and said connection portion 36 by means of a jig 90.

Examples of applications of the invention are contacts for use in electric and electronic appliances such as digital cameras, video cameras, mobile phone terminals, and the like, and particularly contacts having superior means for fixing them.

While the invention has been particularly shown and described with reference to the preferred embodiments thereof, it will be understood by those skilled in the art that the foregoing and other changes in form and details can be made therein without departing from the spirit and scope of the invention.

1. A contact including a contact portion adapted to contact a mating object, a fixed portion to be fixed to a housing, and a connection portion to be connected to a connecting object,
wherein said fixed portion of said contact is bent substantially vertically to form bent pieces whose end faces are pushed to insert the contact into said housing when the contact is fixed to said housing.

2. An L-shaped contact including a contact portion adapted to contact a mating object, a fixed portion to be fixed to a housing, and a connection portion to be connected to a connecting object,
wherein said L-shaped contact is formed between said fixed portion and said connection portion with a bent portion which is formed with a hole whose end face is pushed to insert the contact into said housing when the contact is fixed to said housing.

3. A connector, wherein when the contact as claimed in claim 1 is fixed to said housing, said contact is inserted into said housing by pushing said end faces of said bent pieces or said end face of said hole.

4. A connector, wherein when the contact as claimed in claim 2 is fixed to said housing, said contact is inserted into said housing by pushing said end faces of said bent pieces or said end face of said hole.
